(19) United States
(12) Patent Application Publication
(10) Pub. No.: US 2019/0384117 A1
(43) Pub. Date: Dec. 19, 2019

(54) DISPLAY DEVICE

(71) Applicant: InnoLux Corporation, Miao-Li County (TW)

(72) Inventors: Wen-Jyh SAH, Miao-Li County (TW); Wen-Chuan CHANG, Miao-Li County (TW)

(21) Appl. No.: 16/551,825

(22) Filed: Aug. 27, 2019

Related U.S. Application Data
(62) Division of application No. 14/887,438, filed on Oct. 20, 2015.

(30) Foreign Application Priority Data
Oct. 21, 2014 (TW) 103136246

(51) Int. Cl. G02F 1/1335; F21V 8/00

(52) U.S. Cl. CPC G02F 1/133609; G02B 6/0068; G02F 1/133603

(57) ABSTRACT

A display device is provided, including a panel, a plurality of first light sources, and a plurality of second light sources. The panel includes a first display area and a second display area. The first light sources correspond to the first display area. The second light sources correspond to the second display area. The color of the second light sources is different from the color of the first light sources. When the brightness of the second light sources is increased, the brightness of the first light sources decreases, and when the brightness of the first light sources is increased, the brightness of the second light sources decreases.

### CROSS REFERENCE TO RELATED APPLICATIONS

This application is a Divisional of U.S. patent application Ser. No. 14/887,438, filed Oct. 20, 2015 and entitled “DISPLAY DEVICE”, which claims priority of Taiwan Patent Application No. 103136246, filed on Oct. 21, 2014, the entirety of which is incorporated by reference herein.

### BACKGROUND OF THE INVENTION

### Field of the Invention

The present invention relates to a display device, and in particular to a display device with regionally high color saturation.

### Description of the Related Art

FIG. 1 shows conventional display device C1, which utilizes white LEDs W as light sources of a backlight module. The backlight module provides white back light directed toward a display panel. When the warning area of the display panel requires light of another color (for example, a red light) for warning the user, a plurality of red LEDs R which are arranged between the white LEDs W provide the red light. Conventionally, the white LEDs W and the red LEDs R are staggered and located on the same plane. Therefore, in the edge of the warning area, the red light provided by the red LEDs R is intermixed with the white light provided by the white backlight (intermix area P), and the color saturation of the red light is reduced, lowering the effectiveness of the warning.

### BRIEF SUMMARY OF THE INVENTION

In one embodiment, a display device is provided, including a panel, a circuit board, a plurality of first light sources, a plurality of second light sources and a plurality of third light sources. The panel comprises a first display area and a second display area. The circuit board comprises a first area and a second area. The first light sources are disposed in the first area and corresponding to the first display area. The second light sources are disposed in the second area and corresponding to the second display area. A color of the second light sources is different from a color of the first light sources. A distance between the first light sources and the panel is different from a distance between the second light sources and the panel.

In one embodiment, the display device as comprises a plurality of third light sources disposed in the first area and corresponding to the first display area, wherein a color of the third light sources is the same as the color of the second light sources.

In one embodiment, when brightness of the second light sources is increased, brightness of the first light sources decreases, and when the brightness of the first light sources is increased, the brightness of the second light sources decreases.

In one embodiment, the circuit board further comprises a stage, the stage is disposed in the first area, and the first light sources are disposed on the stage.

In one embodiment, a cross section of the stage is rectangular or trapezoidal.

In one embodiment, the stage comprises a reflective lateral surface.

In one embodiment, the reflective lateral surface is an inclined surface, and an included angle between the reflective lateral surface and the panel is greater than 30 degrees and smaller than 90 degrees.

In one embodiment, the circuit board further comprises a partition, and the partition surrounds the first area.

In one embodiment, a display device is provided, including a panel, a circuit board, a plurality of first light sources, a plurality of second light sources and a partition. The panel comprises a first display area and a second display area. The circuit board comprises a first area and a second area. The first light sources are disposed in the first area and corresponding to the first display area. The second light sources are disposed in the second area and corresponding to the second display area. The partition is disposed at a border between the first area and the second area. A color of the second light sources is different from a color of the first light sources.

In one embodiment, the display device further comprises a plurality of third light sources disposed in the first area and corresponding to the first display area, wherein a color of the third light sources is the same as the color of the second light sources.

In one embodiment, the partition is a reflective wall.

In one embodiment, one of the first light sources neighboring the border has a first collimating element, and the first collimating element collimates a light emitted from the first light source.

In one embodiment, one of the second light sources neighboring the border has a second collimating element, and the second collimating element collimates a light emitted from the second light source.

In one embodiment, a display device is provided, comprising a panel, a first circuit board, a second circuit board, a plurality of first light sources, a plurality of second light sources and a light guide. The panel comprises a first display area and a second display area. The first circuit board comprises a first area. The second circuit board comprises a second area. The first light sources are disposed in the first area and corresponding to the first display area. The second light sources are disposed in the second area and corresponding to the second display area. The light guide comprises a first light-entering surface facing the second light sources. A normal vector of the first area is substantially perpendicular to a normal vector of the second area.

In one embodiment, the display device further comprises a plurality of third light sources disposed in the first area and corresponding to the first display area, wherein a color of the third light sources is the same as the color of the second light sources.

In one embodiment, the normal vector of the second area is parallel to a normal vector of the first display area and the second display area, the second light sources further corresponds to the first display area, and the light guide further comprises a second light-entering surface facing the first light sources.

In one embodiment, the first light-entering surface is perpendicular to the second light-entering surface.

In one embodiment, the normal vector of the first area is parallel to a normal vector of the first display area and the second display area, and the light guide comprises a hollow portion corresponding to the first area.

In one embodiment, the normal vector of the first area is parallel to a normal vector of the first display area and the second display area, and the light guide further comprises a second light-entering surface facing the first light sources.

In one embodiment, the first light-entering surface is perpendicular to the second light-entering surface.

In the embodiment of the invention the color gamut (CG) of the first display area is increased more than 0.5%. Additionally, utilizing the embodiment of the invention, when the first light sources 33 are activated, the width of the color variation area located between the first display area and the second display area is decreased to 1 cm, and the color variation therein is slight. The embodiments of the invention improves the light intermix problem in the conventional art.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional display device;

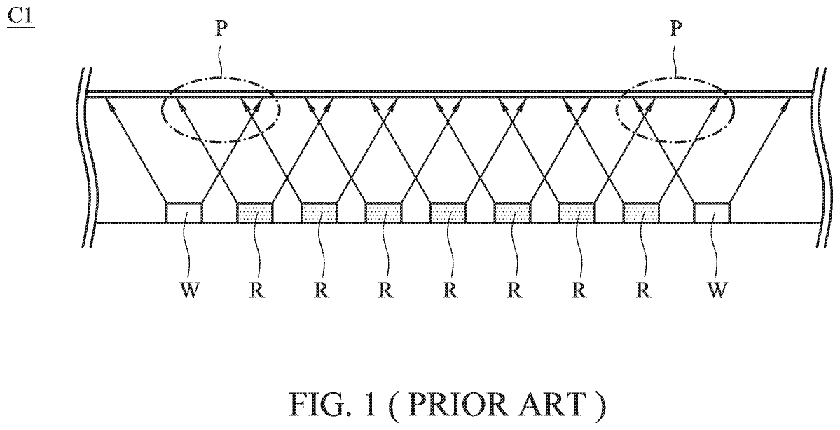

FIG. 2A shows a display device of a first embodiment of the invention, wherein the third lights sources are deactivated;

FIG. 2B shows the display device of the first embodiment of the invention, wherein the third lights sources are activated;

FIG. 2C shows a display device of a modified example of the first embodiment of the invention;

FIG. 3A shows a stage of an embodiment of the invention;

FIG. 3B shows a stage of another embodiment of the invention;

FIG. 4 shows a display device of a second embodiment of the invention;

FIG. 5 shows a display device of a third embodiment of the invention;

FIG. 6 shows a display device of a fourth embodiment of the invention;

FIG. 7 shows a display device of a fifth embodiment of the invention;

FIG. 8 shows a display device of a sixth embodiment of the invention; and

FIG. 9 shows a color saturation variation of the first display area of one of the embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

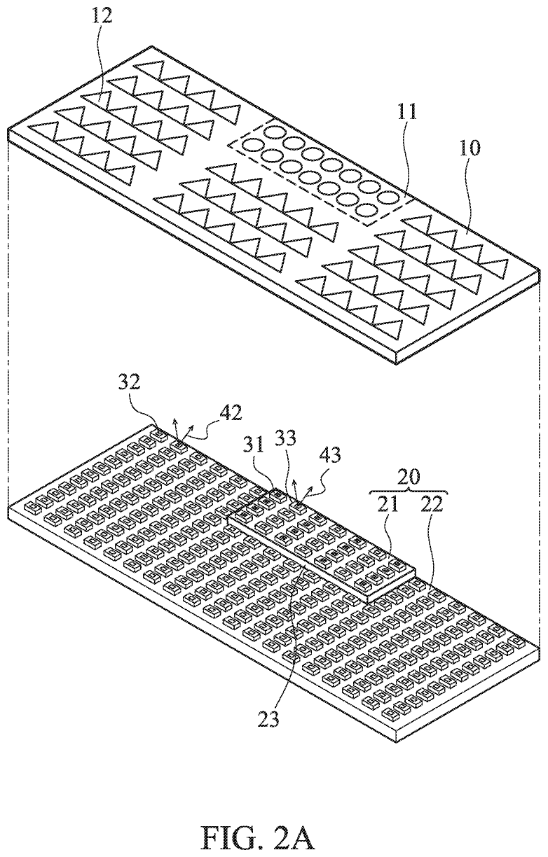

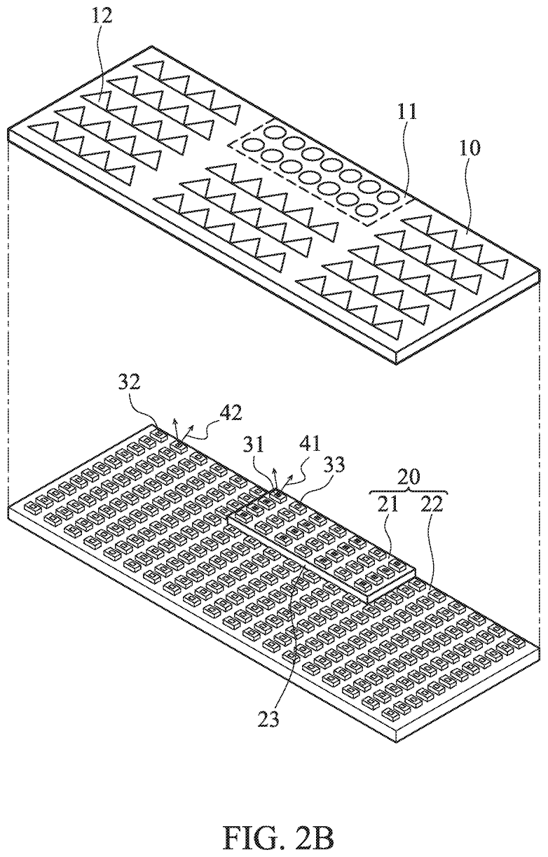

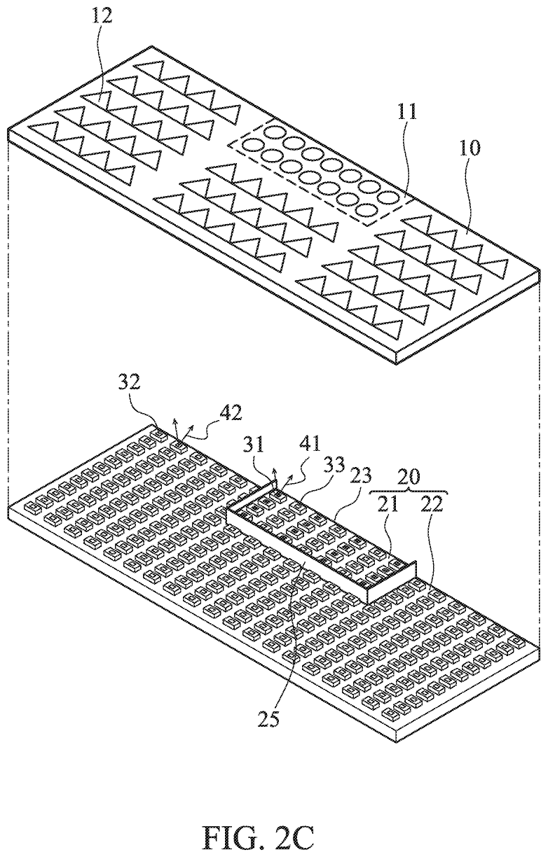

FIGS. 2A and 2B shows a display device of a first embodiment of the invention, which includes a panel 10, a circuit board 20, a plurality first light sources 31, a plurality of second light sources 32 and a plurality of third light sources 33. The panel 10 comprises a first display area 11 and a second display area 12. The first light sources 31 correspond to the first display area 11, and provide a light 41 as warning light. The second light sources 32 correspond to the second display area 12, and provide a light 42 as backlight. The third light sources 33 correspond to the first display area 11, and provide a light 43 as backlight. A color (color saturation) of the light 41 from the first light sources 31 is different from the color of the light 43 from the third light sources 33. When the brightness of the first light sources 31 is increased (for example, turned on), the brightness of the third light sources 33 is decreased (for example, turned off, the brightness of the third light sources 33 decreases to zero, with reference to FIG. 2B). When the brightness of the third light sources 33 is increased (for example, turned on), the brightness of the first light sources 31 decreases (for example, turned off, the brightness of the first light sources 31 decreased to zero, with reference to FIG. 2A). In FIGS. 2A and 2B, the light beams are examples, and are not meant to restrict the invention.

The panel 10 of the embodiments can be a liquid-crystal display panel, a pattern covered panel or a panel with special function, such as touch panel or 3D display panel. In one example, the panel 10 is a liquid-crystal display panel comprising two opposite substrates, a liquid-crystal layer between the two substrates, and other driving and optical structures, such as TFT, electrodes, conductive lines, color filter, black matrix and polarization sheets. The liquid-crystal display panel associated with the touch sensing element is a touch panel. The liquid-crystal display panel associated with an optical grating structure or prism structure is a 3D display panel. Additionally, the panel 10 can be a panel with partially transparent and partially covered characteristics, such as a plastic panel or a metal panel with a hollow portion.

The circuit board of the embodiments can be a printed circuit board (PCB) associated with printed circuit board assembly (PCBA). The first light sources 31, second light sources 32 and third light sources 33 can be LEDs, OLEDs, CCFLs or QD light emitters. The brightness, the color and the power of the first light sources 31, second light sources 32 and third light sources 33 can be the same or different. In one example, the second light sources 32 and the third light sources 33 are white LEDs with the same brightness, color and power. The first light sources 33 can be red LEDs with increased brightness, color and power to intensify the warning effect. The ratio between the number of first light sources and the number of third light sources is between 1.4 and 2.2.

The second display area 12 of the panel 10 is utilized to display images, and can display an image on its own, or in combination with the first display area 11. In an image display mode, the brightness and the color of the backlights of the first display area 11 and the second display area 12 are substantially the same, and the panel 10 has the same function as a common display panel. In a warning display mode, the first display area 11 has a warning pattern, and the backlight provided by the first light sources 31 presents the warning pattern with high brightness and high color saturation.

The circuit board 20 comprises a first area 21 and a second area 22. The first area 21 corresponds to the first display area 11, and the second area 22 corresponds to the second display area 12. In this embodiment, the first light sources 31 and the third light sources 33 are disposed in the first area 21, and the second light sources 32 are disposed in the second area 22. Note that the number per unit area of the third light sources 33 in the first area 21 is smaller than the number per unit area of the second light sources 32 in the second area 22 in several embodiments of the invention, but this is not to restrict the invention. In other embodiments not shown in the disclosure of the invention, the number per unit area of the third light sources 33 in the first area 21 is the same as the number per unit area of the second light sources 32 in the second area 22. In those not shown embodiments, the first light sources 31 are provided adjacent to the third light sources 33. Therefore, the number per unit area of light sources, including first light sources 31 and third light sources 33, in the first area 21 is larger than the second light sources 32 in the second area 22.

With reference to FIG. 2A, in this embodiment, the circuit board 20 further comprises a stage 23. The stage 23 is disposed in the first area 21, and the first light source 31 and the third light sources 33 are disposed on the stage 23. In other words, a first distance between the first light sources 31 and the panel 10 is different from a second distance between the second light sources 32 and the panel 10. More specifically, the first distance is smaller than the second distance. In one example, the stage 23 is made of insulating materials, such as plastic, resin or glass. The height of the stage 23 is greater than the height of the light sources, and smaller than the difference between the height of a backlight module chamber and the height of the light sources. In one example, the height of the stage 23 is between ¼ and ¾ of the height of the backlight module chamber.

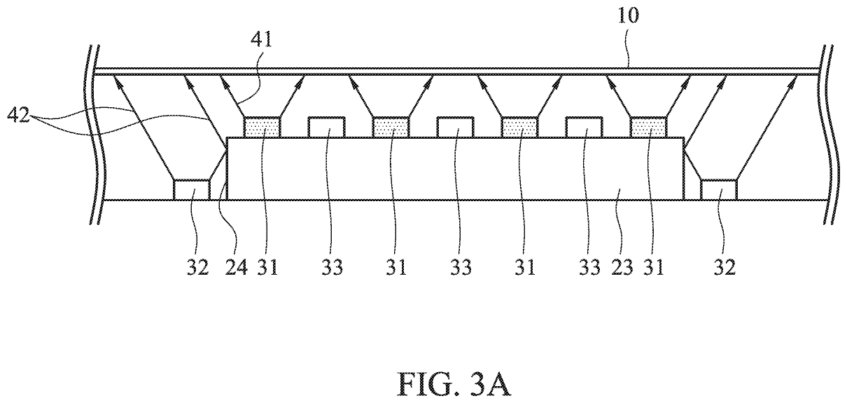

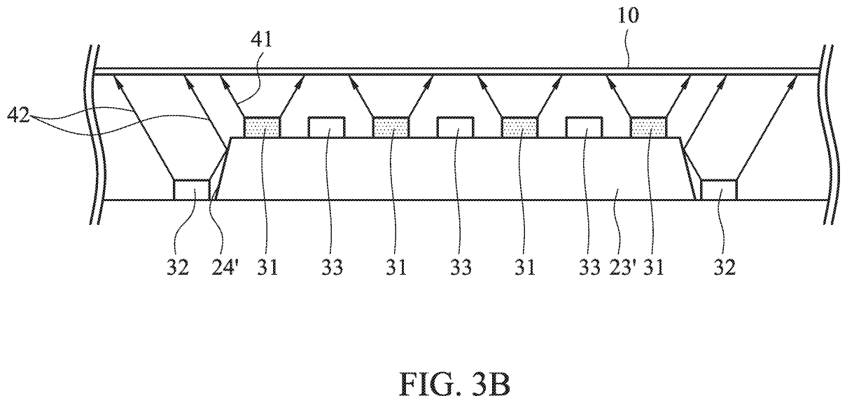

FIG. 3A shows the stage of an embodiment of the invention. In FIG. 3A, the arrangement and the number of first light sources 31, second light sources 32 and third light sources 33 are an example, and are not to restrict the invention. In one embodiment, the stage 23 is a cube with a rectangular cross section. The stage 23 has a reflective lateral side 24. In other embodiments, the stage 23 can have a different cross section, such as hexagonal or circular. The reflective lateral side 24 can be a reflective layer or a reflective sheet made of white polyethylene terephthalate (PET) or white polypropylene (PP).

FIG. 3B shows the stage of another embodiment of the invention. In FIG. 3B, the arrangement and the number of first light sources 31, second light sources 32 and third light sources 33 are an example, and should not restrict the invention. The stage 23′ has a trapezoidal cross section. The stage 23′ has a reflective lateral side 24′. The reflective lateral side 24′ is an inclined surface. It is preferred that an included angle between the inclined surface and the bottom surface of the backlight module is greater than 30 degrees and smaller than 90 degrees.

With reference to FIG. 2C, in one embodiment, the circuit board 20 further comprises a partition. The partition is a disposed at a border between the first area 21 and the second area 22. The partition is for example a reflective wall 25, and the reflective wall 25 surrounds the first area 21. In one embodiment, the reflective wall 25 can be a white reflective layer or a white reflective sheet made of white polyethylene terephthalate (PET) or white polypropylene (PP). Note that the partition as a reflective wall 25 should not restrict the invention. Any opaque object can be used as a partition.

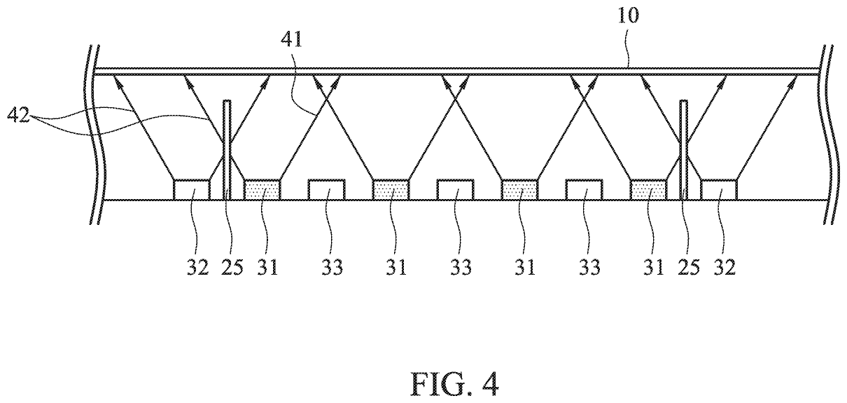

FIG. 4 shows a display device of a second embodiment of the invention, wherein the circuit board 20 has no stage, and a partition such as the reflective wall 25 surrounds the first area 21. The first light sources 31, second light sources 32 and third light sources 33 are coplanar. In FIG. 4B, the arrangement and the number of first light sources 31, second light sources 32 and third light sources 33 are an example, and are not meant to restrict the invention. In this embodiment, the reflective wall 25 separates the second area from the first area.

Utilizing the first or second embodiment, the lights emitted from the light sources are not intermixed, and the color saturation of the first display area and the second display area is maintained or improved.

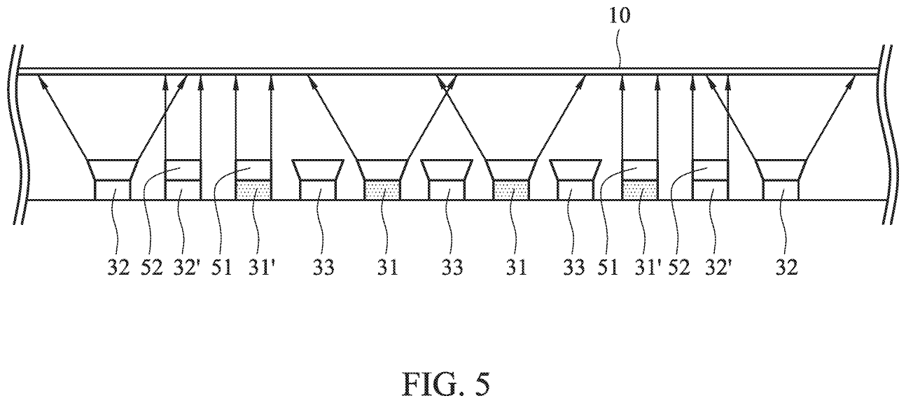

FIG. 5 shows a third embodiment of the invention. In FIG. 5, the arrangement and the number of first light sources 31, second light sources 32 and third light sources 33 are an example, and are not meant to restrict the invention. In the third embodiment, the second light sources comprise a plurality of second border light sources 32′ which are neighboring a border located between the first area and the second area. One of the second border light sources 32′ has a second collimating element 52, and the second collimating element 52 collimates light emitted from the second border light sources 32′. The full width at half-maximum of the light provided by the second border light sources 32′ is reduced, and the color saturation of the warning image of the second display area is maintained.

In one embodiment, the first light sources comprise a plurality of first border light sources 31′ which are neighboring the border located between the first area and the second area. One of the first border light sources 31′ has a first collimating element 51, and the first collimating element 51 collimates light emitted from the first border light sources 31′. The full width at half-maximum of the light provided by the first border light sources 31′ is reduced, and the color saturation of the image of the first display area is maintained.

Utilizing the third embodiment, the light provided neighboring the border located between the first area and the second area is collimated by collimating elements. The lights emitted from the light sources are not intermixed, and the color saturations of the first display area and the second display area is maintained or improved.

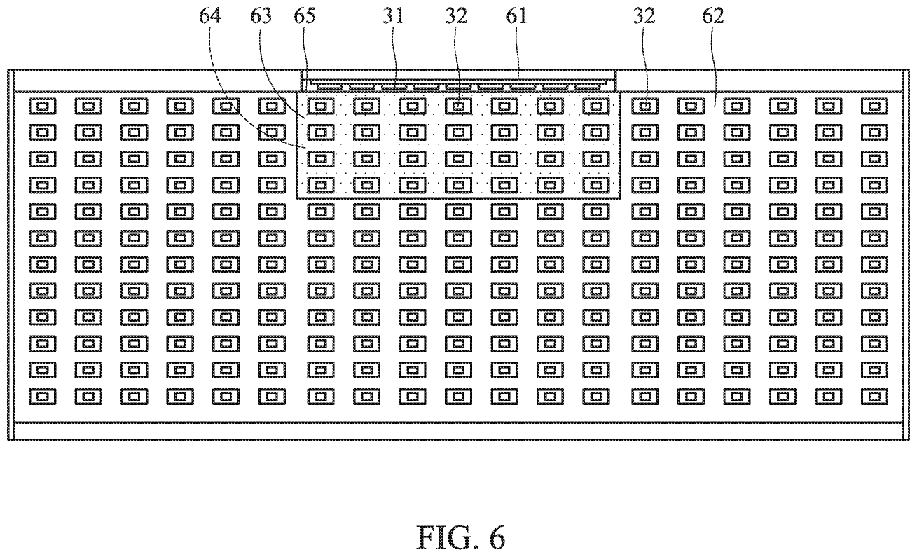

FIG. 6 shows a fourth embodiment of the invention. In FIG. 6, the arrangement and the number of first light sources 31 and the second light sources 32 are an example, and are not meant to restrict the invention. In this embodiment, the display device comprises a first circuit board 61, a light guide 63 and a second circuit board 62. The second circuit board 62 comprises a second area. A portion of the second light sources 32 are disposed in a portion of the second area (covered by the light guide 63) and correspond to the second display area. The first circuit board 61 comprises a first area. The first light sources 31 are disposed in the first area and correspond to the first display area. Another portion of the second light sources 32 are disposed in another portion of the second area (covered by the light guide 63) and correspond to the first display area. In this embodiment, the normal vector of the second area is parallel to a normal vector of the first display area and the second display area.

In the fourth embodiment, the light guide 63 comprises a first light-entering surface (bottom surface) 64 and a second light-entering surface (lateral surface) 65, the first light-entering surface 64 is perpendicular to the second light-entering surface 65, the first light sources 31 face the second light-entering surface 65, and the second light sources 32 face the first light-entering surface 64.

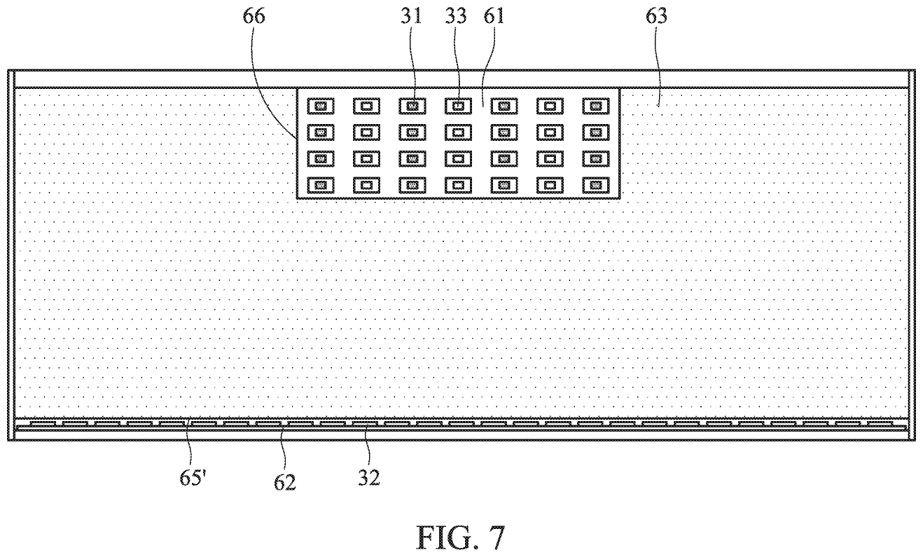

FIG. 7 shows a fifth embodiment of the invention. In FIG. 7, the arrangement and the number of first light sources 31, second light sources 32 and third light sources 33 are an example, and are not meant to restrict the invention. In this embodiment, the display device comprises a first circuit board 61, a light guide 63 and a second circuit board 62. The first circuit board 61 comprises a first area. The second circuit board 62 comprises a second area. The light guide 63 comprises a light-entering surface (lateral surface) 65′, and a hollow portion 66 is formed on the light guide 63. The hollow portion 66 corresponds to the first display area, and the light guide corresponds to the second display area. The second light sources 32 are disposed on the second area and face the light-entering surface 65′ to provide a second back light toward the light guide 63. The first light sources 31 and the third light sources 33 are disposed on the first area and face the hollow portion 66. The first light sources 31 and the third light sources 33 correspond to the first display area and provide backlight selectively. In this embodiment, the normal vector of the first area is parallel to a normal vector of the first display area and the second display area.

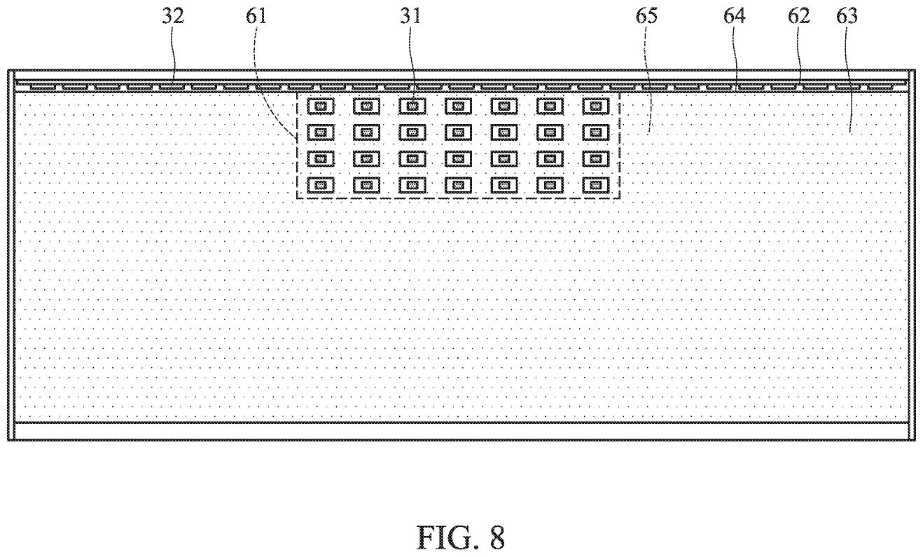

FIG. 8 shows a sixth embodiment of the invention. In FIG. 8, the arrangement and the number of first light sources 31 and second light sources 32 are an example, and are not meant to restrict the invention. In the sixth embodiment, a plurality of first light sources 31 are disposed on the first area of the first circuit board 61. The second light sources 32 are disposed on the second area of the second circuit board 62. The light guide 63 corresponds to the first and second display area. The light guide 63 comprises a first light-entering surface (lateral surface) 64 and a second light-entering surface (bottom surface) 65. The first light-entering surface 64 is perpendicular to the second light-entering surface 65. The second light sources 32 face the first light-entering surface 64 and correspond to the second display area. The first light sources 31 face the second light-entering surface 65 and correspond to the first display area. In this embodiment, the normal vector of the first area is parallel to a normal vector of the first display area and the second display area.

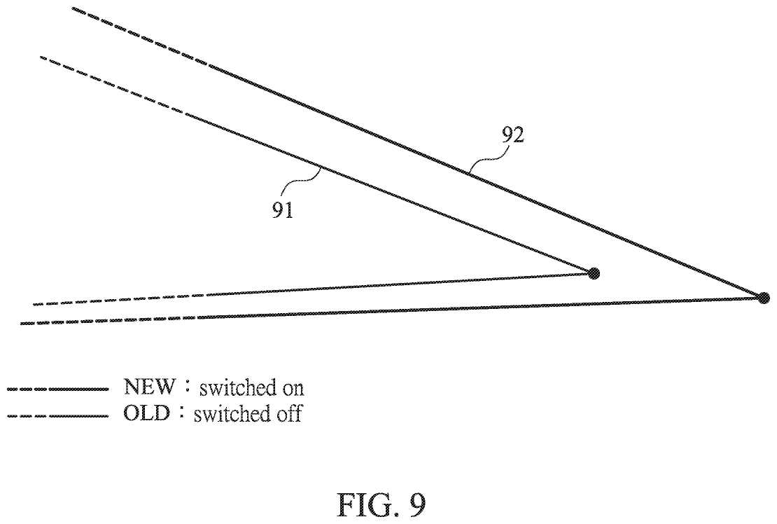

With reference to FIG. 9, compared to the prior art, the embodiment of the invention utilizes red LEDs with high brightness and high color saturation to increase the color gamut (CG) of the first display area more than 0.5% (original CG is greater than 72% NTSC). Additionally, utilizing the embodiment of the invention, when the first light sources 33 are activated, the width of a color variation area located between the first display area and the second display area is decreased to 1 cm, and the color variation therein is slight. The embodiments of the invention improve the light intermix problem of the conventional art.

In one embodiment, the third light sources 33 are red LEDs. The first light sources 31 are white LEDs. The second light sources 32 are white LEDs. In one embodiment, a number of third light sources 33 is greater than an number of first light sources 31. For example, in one embodiment, the ratio between the number of third light sources and the number of first light sources is between 1.7 and 2.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a panel, comprising a first display area and a second display area;
a circuit board, comprising a first area and a second area;
a plurality of first light sources, disposed in the first area and corresponding to the first display area;
a plurality of second light sources, disposed in the second area and corresponding to the second display area;
wherein a color of the second light sources is different from a color of the first light sources;
wherein a distance between the first light sources and the panel is different from a distance between the second light sources and the panel.

2. The display device as claimed in claim 1, further comprising a plurality of third light sources disposed in the first area and corresponding to the first display area, wherein a color of the third light sources is the same as the color of the second light sources.

3. The display device as claimed in claim 1, wherein when brightness of the second light sources is increased, brightness of the first light sources decreases, and when the brightness of the first light sources is increased, the brightness of the second light sources decreases.

4. The display device as claimed in claim 1, wherein the circuit board further comprises a stage, the stage is disposed in the first area, and the first light sources are disposed on the stage.

5. The display device as claimed in claim 4, wherein a cross section of the stage is rectangular or trapezoidal.

6. The display device as claimed in claim 4, wherein the stage comprises a reflective lateral surface.

7. The display device as claimed in claim 6, wherein the reflective lateral surface is an inclined surface, and an included angle between the reflective lateral surface and the panel is greater than 30 degrees and smaller than 90 degrees.

8. The display device as claimed in claim 1, wherein the circuit board further comprises a partition, and the partition surrounds the first area.

9. A display device, comprising:
a panel, comprising a first display area and a second display area;
a first circuit board, comprising a first area;
a second circuit board, comprising a second area;
a plurality of first light sources, disposed in the first area and corresponding to the first display area; and
a plurality of second light sources, disposed in the second area and corresponding to the second display area; and
a light guide, comprising a first light-entering surface facing the second light sources;
wherein a normal vector of the first area is substantially perpendicular to a normal vector of the second area.

10. The display device as claimed in claim 9, further comprising a plurality of third light sources disposed in the first area and corresponding to the first display area, wherein a color of the third light sources is the same as the color of the second light sources.

11. The display device as claimed in claim 9, wherein the normal vector of the second area is parallel to a normal vector of the first display area and the second display area, the second light sources further corresponds to the first display area, and the light guide further comprises a second light-entering surface facing the first light sources.

12. The display device as claimed in claim 11, wherein the first light-entering surface is perpendicular to the second light-entering surface.

13. The display device as claimed in claim 9, wherein the normal vector of the first area is parallel to a normal vector of the first display area and the second display area, and the light guide comprises a hollow portion corresponding to the first area.

14. The display device as claimed in claim 9, wherein the normal vector of the first area is parallel to a normal vector of the first display area and the second display area, and the light guide further comprises a second light-entering surface facing the first light sources.

15. The display device as claimed in claim 14, wherein the first light-entering surface is perpendicular to the second light-entering surface.
